(19) United States
(12) Patent Application Publication
(10) Pub. No.: US 2024/0090477 A1
(43) Pub. Date: Mar. 21, 2024

(54) Automatic Chicken Coop Door&Chicken Coop

(71) Applicant: Dongguan Kaisen Electromechanical Equipment Technology Co., Ltd., Dongguan City (CN)

(72) Inventor: Kunlin Zeng, Dongguan City (CN)

(21) Appl. No.: 17/954,634

(22) Filed: Sep. 28, 2022

(30) Foreign Application Priority Data
Sep. 15, 2022 (CN) 202230608079.1

(51) Int. Cl. A01K 31/02; A01K 31/18

(52) U.S. Cl. CPC A01K 31/02; A01K 31/18

(57) ABSTRACT

The present application relates to an automatic chicken coop door and chicken coop and, more particularly, to an automation control technology, and the automatic door includes: a door body, a trigger device, a controller and a motor, and the door body is set at the periphery of the chicken coop. In practice, when the trigger device reaches the preset trigger conditions, it will send a trigger signal to the controller, and the controller will control the motor to drive the door to open/close automatically according to the trigger signal. The technical scheme of the present application controls the door body to open/close automatically when reaching the preset trigger conditions through the synchronization of the trigger device and the motor, which is not only more convenient for controlling the chicken coop door body, but also saves human resources.

### FIELD OF TECHNOLOGY

The present application relates to the field of automation control technology, and in particular, to an automatic chicken coop door and chicken coop.

### Background of Technology

Chicken coop is the place where chickens roost, and according to the breeding method, chicken coops can be divided into: flat-ground coop, cage coop and free-range coop. The free-range coop, in particular, not only provides a roosting place for chickens, but also offers an outdoor activity field for chickens, and this kind of coop needs to be equipped with a door to ensure that chickens can leave and return to the coop as required. According to the technology existing, generally, the door is opened/closed manually, however, manual operation is not only laborious but also a waste of human resources.

### Terms of the Invention

In order to resolve, at least to a certain extent, the problem that manual operation for the door of chicken coop according to the corresponding technology is not only laborious but also wasteful by manually controlling the coop door, the present application provides an automatic chicken coop door and chicken coop.

The scheme of the present application is as follows:

In the first aspect of the exemplary embodiment of the present application, an automatic chicken coop door comprises:

A door body, a trigger device, a controller and a motor;

The door body is set at the periphery of the chicken coop;

The trigger device is used to send a trigger signal to the controller when reaching preset trigger conditions;

The controller is used to control the motor to drive the door body to open/close according to the trigger signal.

Preferably the trigger device comprises:

A timer;

The timer is used to send a first timing trigger signal to the controller when reaching a first preset time; to send a second timing trigger signal to the controller when reaching a second preset time;

The controller, according to the first timing trigger signal, controls the motor to drive the door body to open; and according to the second timing trigger signal, controls the motor to drive the door body to close.

Preferably the trigger device comprises:

A photosensitive sensor;

The photosensitive sensor is used to send a first light trigger signal to the controller when subjected to a first preset light level; send the second light trigger signal to the controller when receiving a second preset brightness;

The controller controls the motor to drive the door body to open according to the first light trigger signal; and controls the motor to drive the door body to close according to the second light trigger signal.

Preferably the trigger device comprises:

A remote control device;

The remote control device is used to send a remote control trigger signal to the controller.

The controller controls the motor to drive the door body to open/close according to the remote control trigger signal.

Preferably it further includes: an indicator light and an infrared sensor;

The controller controls the indicator light to send a first indication while controlling the motor to drive the door body to open; controls the indicator light to send a second indication while controlling the motor to drive the door body to close;

The infrared sensor is set on the side of the door body;

The controller, while controlling the motor to drive the door body to close, detects infrared information at the door body by the infrared sensor, and controls the motor to bounce open when infrared activity information other than that of the door body is detected at the door body.

Preferably it further includes: a load detection startup circuit;

The load detection startup circuit comprises:

A first output, a second output, a third output, a fourth output, a first input, a second input, a first triode, a second triode, a first resistor, a second resistor, a third resistor, a fourth resistor, a fifth resistor, a sixth resistor, a seventh resistor, a first switch, a second switch, a first diode and a first photo-coupler;

The first triode is NPN-type and the second triode is PNP-type;

The controller is connected to the first output, second output, third output, fourth output, first input, second input and first photo-coupler, respectively;

The first input and second input are connected to a power source; The first triode has: emitting electrode connected to the first input; base electrode connected to the first input through the first resistor and further connected to the first output and the second output through the second resistor and the third resistor; collector electrode connected to the first photo-coupler;

The second triodehas: emitting electrode connected to the second input; base electrode connected to the second input through the seventh resistor, and further connected to the third output and the fourth output through the fourth resistor and the fifth resistor; collector electrode connected to the first photo-coupler through said sixth resistor and the first diode;

The first switch is connected to both ends of the first resistor and the third resistor;

The second switch is connected to both ends of the fourth resistor and the seventh resistor.

Preferably it further includes: a moisture detection circuit;

The moisture detection circuit comprises:

A first moisture detection loop circuit, a second moisture detection loop circuit, a first capacitor, a second capacitor, an eighth resistor, a ninth resistor and a second photo-coupler;

The controller is further connected to the second photo-coupler;

The first moisture detection loop circuit surrounds the first output and the second output, and is connected to the second photo-coupler through the eighth resistor;

The second moisture detection loop circuit surrounds the third output and the fourth output, and is connected to the second photo-coupler through the ninth resistor;

The first input is connected to the second photo-coupler through the first capacitor;

The second input is connected to the second photo-coupler through the second capacitor.

Preferably it further includes: an overcurrent detection circuit;

The overcurrent detection circuit comprises:

A first instrument transformer, a first rectifier bridge, a tenth resistor, an eleventh resistor, a twelfth resistor, a thirteenth resistor, a third capacitor, a fourth capacitor, a second diode, a third diode, a voltage-regulator tube and a third triode;

The input of the first instrument transformer is connected to the load detection startup circuit, and its output is connected to the input of the first rectifier bridge;

The output of the first rectifier bridge connects in parallel with the tenth resistor, eleventh resistor, twelfth resistor, third capacitor, fourth capacitor, and second diode, respectively;

The positive electrode of the output of the first rectifier bridge is connected to base electrode of the third triode through the third diode, voltage-regulator tube and thirteenth resistor, with the negative electrode being grounded;

The emitting electrode of the third triode is grounded and collector electrode is connected to the controller.

Preferably it further includes: a leakage detection circuit;

The leakage detection circuit comprises:

An external power source, a second instrument transformer, a second rectifier bridge, a fourteenth resistor, a fifteenth resistor, a sixteenth resistor, a fifth capacitor, a fourth diode, a fifth diode, a sixth diode and a comparator;

The input of the second instrument transformer is connected to the load detection startup circuit and its output is connected to the input of the second rectifier bridge;

The positive electrode of the output of the second rectifier bridge is connected to the first negative electrode of the input of the comparator through the fourteenth resistor; further connected to the first negative electrode of the input of the comparator through the fourth diode; further connected to the first negative electrode of the input of the comparator through the fifteenth resistor; and further grounded through the fifth capacitor;

The external power source is connected to the first positive electrode of the input of the comparator through the sixteenth resistor; is further connected to the second positive electrode of the comparator;

The sixteenth resistor is further grounded through the fifth diode;

The second negative electrode of the comparator is grounded;

The output of the comparator is connected to the controller through the sixth diode.

In the second aspect of the exemplary embodiment of the present application, an automatic chicken coop door comprises:

A chicken coop body, and an automatic chicken coop door as claimed in any of the claims.

The technical scheme provided by the present application may include the following beneficial effects: the automatic chicken coop door in the present application comprises: a door body, a trigger device, a controller and a motor, and the door body is set at the periphery of the chicken coop. In practice, when the trigger device reaches the preset trigger conditions, it will send a trigger signal to the controller, and the controller will control the motor to drive the door to open/close automatically according to the trigger signal. The technical scheme of the present application controls the door body to open/close automatically when reaching the preset trigger conditions through the synchronization of the trigger device and the motor, which is not only more convenient for controlling the chicken coop door body, but also saves human resources.

It is understood that the above general descriptions and the later detailed descriptions are only exemplary and explanatory, and do not limit the present application.

### SPECIFICATION OF DRAWINGS

The accompanying drawings herein are incorporated into and form part of the specification, showing the exemplary embodiments which are consistent with the present application, and are used together with the specification to explain the principles of the present application.

FIG. 1 is a schematic block diagram of an automatic chicken coop door provided by an exemplary embodiment of the present application;

FIG. 2 is a schematic diagram of the circuit structure of a load detection startup circuit and a moisture detection circuit provided by an exemplary embodiment of the present application; and

FIG. 3 is a schematic diagram of a circuit structure of an overcurrent detection circuit provided by an exemplary embodiment of the present application; and

FIG. 4 is a schematic diagram of a circuit structure of a leakage detection circuit provided by an exemplary embodiment of the present application; and

FIG. 5 is an external view of schematic diagram of an automatic chicken coop door provided by an exemplary embodiment of the present application; and

FIG. 6 is a section view of an automatic chicken coop door provided by an exemplary embodiment of the present application; and

FIG. 7 is an exploded view of an automatic chicken coop door provided by an exemplary embodiment of the present application.

Attachment marks: door body—1; trigger device—2; controller—3; motor—4; infrared sensor—5; indicator light—6; first output—J1; second output—J2; third output—J3; fourth output—J4; first input—J5; second input—J6; first triode—Q1; second triode—Q2; first resistor—R1; second resistor—R2; third resistor—R3; fourth resistor—R4; fifth resistor—R5; sixth resistor—R6; seventh resistor—R7; first switch—S1; second switch—S2; first diode—D1; first photo—coupler—U1; first moisture detection loop circuit—H1; second moisture detection loop circuit—H2; first capacitor—C1; second capacitor—C2; eighth resistor—R8; ninth resistor—R9; second photo—coupler—U2; first instrument transformer—L1; first rectifier bridge—Z1; tenth resistor—R10; eleventh resistor—R11; twelfth resistor—R12; thirteenth resistor—R13; third capacitor—C3; fourth capacitor—C4; second diode—D2; third diode—D3; voltage—regulator tube—W1; third triode—Q3; second instrument transformer—L2; second rectifier bridge—Z2; fourteenth resistor—R14; fifteenth resistor—R15; sixteenth resistor—R16; fifth capacitor—05; fourth diode—D4; fifth diode—D5; sixth diode—D6; comparator—U3.

### SPECIFIC EMBODIMENT

Exemplary embodiments will be described herein in detail by way of examples in the accompanying drawings. Where the following description relates to the accompanying drawings, unless otherwise indicated, the same numerals in different accompanying drawings indicate the same or similar elements. The embodiments described in the following exemplary embodiments do not represent all embodiments consistent with the present application. On the contrary, these are only examples of devices and methods that are consistent with some aspects of the present application as detailed in the attached claims.

### Exemplary Embodiment I

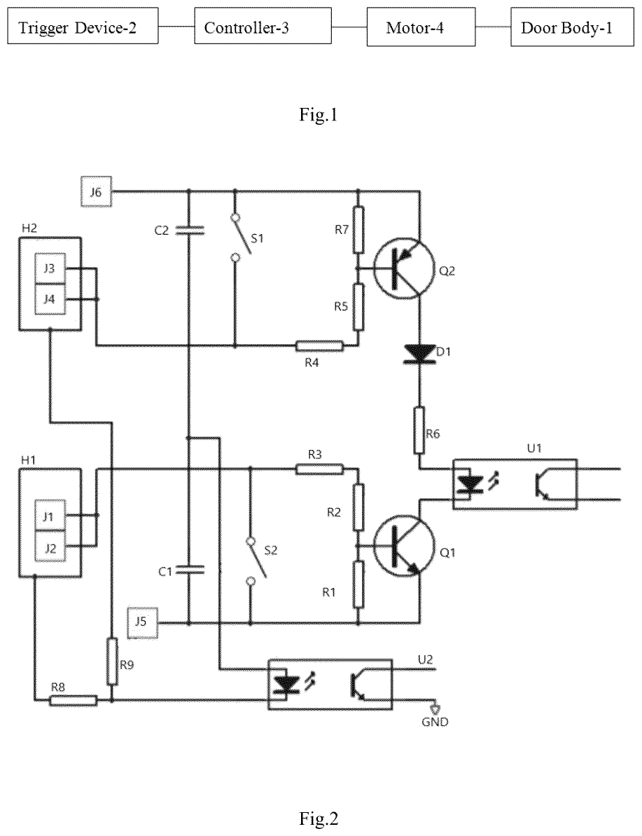

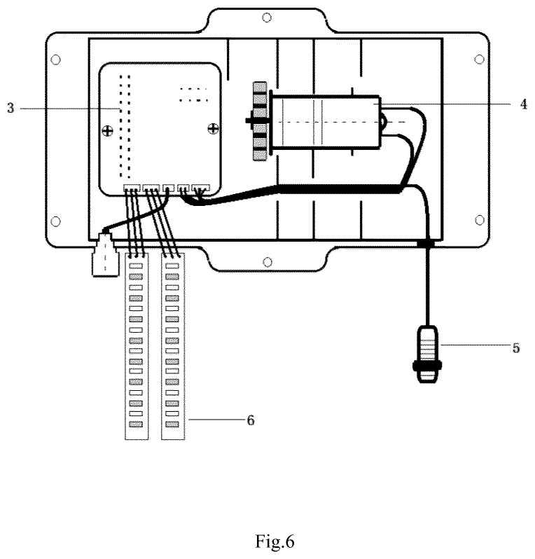

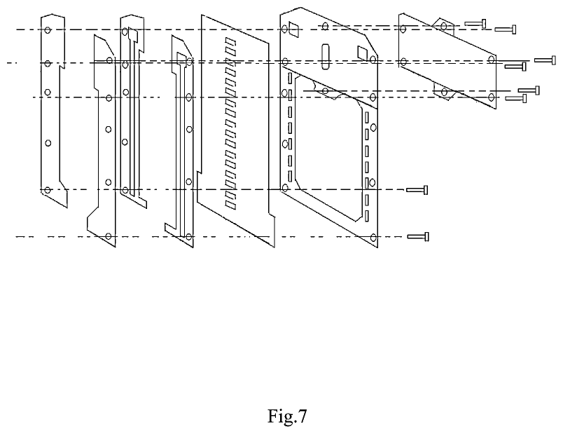

FIG. 1 is a schematic block diagram of an automatic chicken coop door provided by an exemplary embodiment of the present embodiment, with reference to FIG. 1, FIG. 5, FIG. 6 and FIG. 7, and an automatic chicken coop door comprises:

Door body 1, trigger device 2, controller 3 and motor 4;

Door body 1 is set at the periphery of the chicken coop;

Trigger device 2 is used to send a trigger signal to controller 3 when reaching the preset trigger conditions;

Controller 3 is used to control the motor 4 to drive door body 1 to open/close according to the trigger signal.

In practice, trigger device 2 includes a variety of forms, the following three forms of trigger device 2 are listed in this exemplary embodiment.

1) Trigger device 2 includes:

A timer;

The timer is used to send a first timing trigger signal to controller-3 when reaching the first preset time; to send a second timing trigger signal to controller-3 when reaching the second preset time;

Controller 3, according to the first timing trigger signal, control the motor 4 to drive door body 1 to open; and according to the second timing trigger signal, control the motor 4 to drive door body 1 to close.

In this exemplary embodiment, the time for door body 1 to open or close is preset, such as the first preset time is 6:00 a.m. and the second preset time is 6:00 p.m., which can automatically open the door during the daytime and close at night.

2) Trigger device 2 includes:

A photosensitive sensor;

The photosensitive sensor is used to send the first light trigger signal to controller 3 when receiving a first preset brightness; send the second light trigger signal to controller 3 when receiving a second preset brightness;

Controller 3 controls motor 4 to drive door body 1 to open according to the first light trigger signal; and controls motor 4 to drive door body 1 to close according to the second light trigger signal.

Photosensitive sensor is an existing photosensitive element, and the photosensitive resistor is its main element: when it is exposed to the light, the stronger the brightness, the lower the resistance, and the weaker the brightness, the higher the resistance. Therefore, from dawn to dark, the value of photosensitive resistor changes from small to large. This embodiment controls to determine the correspondence between the value of photosensitive resistor and the brightness in advance, and then calculate the resistance value needed to trigger the first lighting trigger signal and the second lighting trigger signal, corresponding to the first preset brightness and the second preset brightness respectively. This exemplary embodiment can realize automatic opening of the door during the daytime and closing at night by setting the brightness corresponding to the resistance value required for the first lighting trigger signal to that at the sunrise time and the brightness corresponding to the resistance value required for the second lighting trigger signal to that at the sunset time.

3) Trigger device 2 includes:

A remote control device;

The remote control device is used to send a remote control trigger signal to controller 3;

Controller 3 controls motor 4 to drive door body 1 to open/close according to remote control trigger signal.

In this exemplary embodiment, a remote control mode for door body 1 is further set, so that the coop manager doesn't have to open/close door body-1 manually but send remote trigger signal to controller 3 through the remote control device to allow motor 4 to drive door body 1 to open/close.

It should be noted that the above-mentioned trigger device 2 can be set up by one, or can be set up with two or all, and there is no limitation under this exemplary embodiment that any specific changes can be made according to the operating environment in practice.

It should be noted that the above-mentioned trigger device 2 is only an example for illustration, and other forms of that could be used in practice without no limitation in trigger device 2 under this exemplary embodiment

In practice, motor 4 can drive door body 1 for up-and-down closure, further drive for left-and-right closure or flip closure, and any specific changes can be made according to the operating environment in practice.

It should be noted that, with reference to FIGS. 5 and 6, the chicken coop further includes: indicator light 6 and infrared sensor 5;

Controller 3 controls indicator light 6 to send first indication while controlling the motor 4 to drive door body 1 to open; and controls indicator light 6 to send second indication while controlling motor 4 to drive door body 1 to close;

Infrared sensor 5 is set on the side of door body 1;

Controller 3, while controlling the motor 4 to drive the door body 1 for closing, further detects infrared information at door body 1 by infrared sensor 5, and controls motor 4 to bounce open when infrared activity information other than door body 1 is detected at door body 1.

In practice, indicator light 6 sends the first indication through the green light and the second indication through the red light, i.e., controller 3 controls the indicator light to green while controlling motor 4 to drive door body 1 to open; and controls the indicator light to red while controlling motor 4 to drive door body 1 to close, helping chicken cooper managers to better understand the opening and closing of the automatic chicken coop door.

It could be understood that by providing infrared sensor 5 on one side of door body 1 in this exemplary embodiment, controller 3, while controlling motor 4 to drive door body 1 for closing, further detects infrared information at door body 1 through infrared sensor 5, and controls motor 4 to bounce open when infrared activity information other than door body 1 (which may be farmed chicken or other objects) is detected at door body 1 to prevent breeding chicken from being crushed when closing.

Preferably infrared sensor 5 is further configured with an infrared indicator. Infrared sensor 5 further give indication through the infrared indicator when the presence of infrared activity information is detected at door body 1 other than the door itself (which may be chickens or other objects).

It could be understood that the automatic chicken coop door in this exemplary embodiment comprises: door body 1, trigger device 2, controller 3 and motor 4, and door body 1 is set at the periphery of the chicken coop. In practice, when trigger device 2 reaches the preset trigger conditions, it will send a trigger signal to controller 3, and controller 3 will control motor 4 to drive door body 1 to open/close automatically according to the trigger signal. The technical scheme of this exemplary embodiment makes it possible to automatically open/close door body-1 when reaching the preset trigger conditions through the synchronization of trigger device 2 and motor 4, which is not only more convenient for controlling door body 1 of chicken, but also saves human resources.

### Exemplary Embodiment II

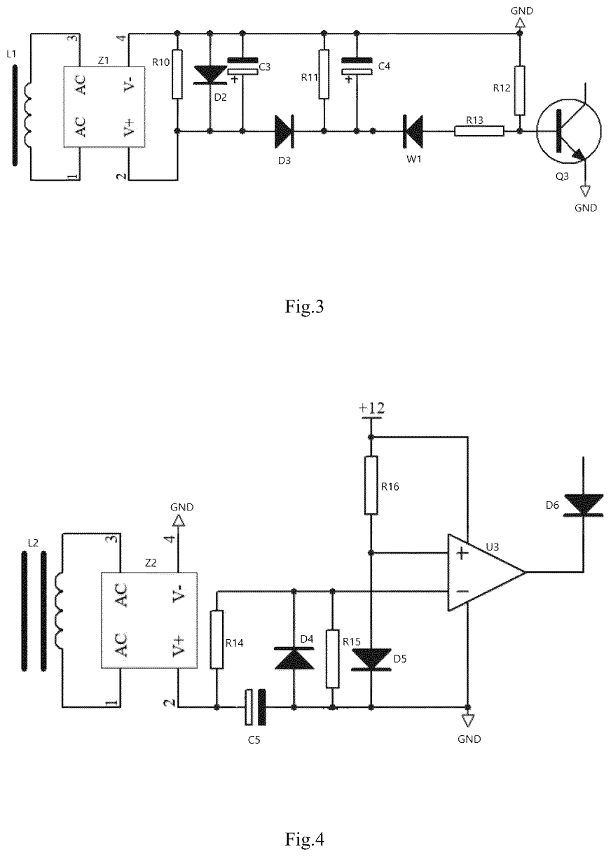

It should be noted that, with reference to FIG. 2, the automatic chicken coop door further includes: load detection startup circuit;

The load detection startup circuit comprises:

First output J1, second output J2, third output J3, fourth output J4, first input J5, second input J6, first triode Q1, second triode Q2, first resistor R1, second resistor R2, third resistor R3, fourth resistor R4, fifth resistor R5, sixth resistor R6, seventh resistor R7, first switch S1, second switch S2, first diode D1, first photo-coupler U1;

First triode Q1 is NPN-type and second triode Q2 is PNP-type;

Controller 3 is connected to first output J1, second output J2, third output J3, fourth output J4, first input J5, second input J6 and first photo-coupler U1, respectively;

First input J5 and second input J6 are connected to a power source;

First triode Q1 has: emitting electrode connected to first input J5; base electrode connected to first input J5 through first resistor R1 and further to first output J1 and second output J2 through second resistor R2 and third resistor R3; collector electrode connected to first photo-coupler U1;

Second triode Q2 has: emitting electrode connected to second input J6; base electrode connected to second input J6 through seventh resistor R7, and further to third output J3 and fourth output J4 through fourth resistor R4 and fifth resistor R5; collector electrode connected to first photo-coupler U1 through sixth resistor R6 and first diode D1;

First switch S1 is connected to both ends of first resistor R1 and third resistor-R3;

Second switch S2 is connected to both ends of fourth resistor R4 and seventh resistor R7.

It should be noted that the load detection startup circuit in this exemplary embodiment comprises four outputs, all four outputs are connected to motor 4, and first input J5 and second input J6 are connected to the 220 power source.

Controller 3 in this exemplary embodiment can be a relay, and each contact of the relay is connected to first output J1, second output J2, third output J3, fourth output J4, first input J5, second input J6 and first photo-coupler U1.

It is understood that, two transistors in this exemplary embodiment are: NPN-type of first triode Q1 and PNP-type of second triode Q2, in which base electrode of first triode Q1 is connected to first output J1 and second output J2 through second resistor R2 and third resistor R3, and base electrode of second triode Q2 is connected to third output J3 and fourth output J4 through fourth resistor R4 and fifth resistor R5. Preferably second resistor R2, third resistor R3, fourth resistor R4 and fifth resistor R5, are 2 MΩ current-limiting resistance, and when there is no load, first transistor Q1 and second transistor Q2 do not conduct, however, when the output of which is connected to the load (i.e., the input for the phase line, such as touching the output with a metal manually), at this time, only one transistor conducts while the other at a high resistance state will not conduct. As there is only one transistor is on at that time, first photo-coupler U1 will not work, the relay will not operate, and as the current flowing through the human body after 2 MΩ current limiting resistor resulting in very low current value, the human body cannot feel the current. When the four outputs are connected to the load, the two transistors conduct at the same time, and the collector electrode of second transistor Q2 transmits current to first photo-coupler U1 through sixth resistor R6 and first diode D1, making the output of first photo-coupler U1 produce a 25 HZ pulse to the relay contact to operation, and further allowing the relay to control input and output closure, and in this case, the load can be powered normally.

It could be understood that, in this exemplary embodiment, first switch S1 and second switch S2 can be used to allow direct connection of the input to the output in the event of damage to the triode or other circuit damage.

It should be noted that, with reference to FIG. 2, the automatic chicken coop door further includes: a moisture detection circuit;

The moisture detection circuit comprises:

First moisture detection loop circuit H1, second moisture detection loop circuit H2, first capacitor C1, second capacitor C2, eighth resistor-R8, ninth resistor R9 and second photo-coupler U2;

Controller-3 is further connected to second photo-coupler U2;

First moisture detection loop circuit H1 surrounds first output J1 and second output J2, and is connected to second photo-coupler U2 through the eighth resistor R8;

Second moisture detection loop circuit H2 surrounds third output J3 and fourth output J4, and is connected to second photo-coupler J4 through the ninth resistor R9;

First input J5 is connected to second photo-coupler U2 through first capacitor C1;

Second input J6 is connected to second photo-coupler U2 through second capacitor C2.

It is understood that, in this exemplary embodiment, referring to FIG. 2, there is a first moisture detection loop circuit H1 at the periphery of first output J1 and second output J2, and a second moisture detection loop circuit H2 at the periphery of third output J3 and fourth output J4, and the moisture detection loop circuit is configured with an insulating resistor. When there is moisture between the output and moisture detection loop circuit, the resistance value of the insulating resistor becomes lower, resulting in the current passing through the eighth resistor R8 or ninth resistor R9 to light up the luminescent tube of second photo-coupler U2, making the output of second photo-coupler U2 produce a 25 HZ pulse to the relay contact to operation, further allowing the relay to disconnect the input and output and cut off the load power supply so as to prevent the load from burning due to water or other problems.

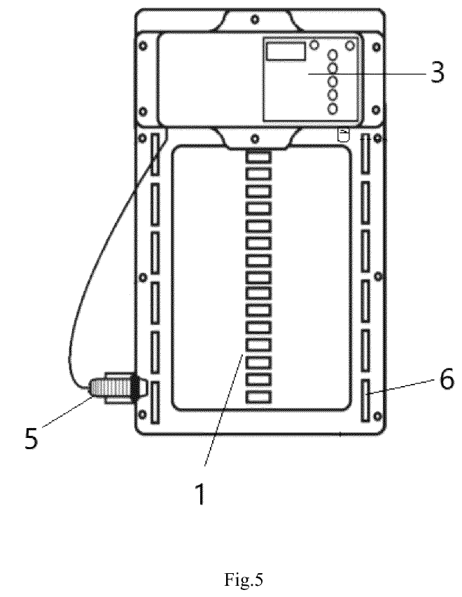

Referring to FIG. 3, an automatic chicken coop door further includes: an overcurrent detection circuit;

The overcurrent detection circuit comprises:

First instrument transformer L1, first rectifier bridge Z1, tenth resistor R10, eleventh resistor R11, twelfth resistor R12, thirteenth resistor R13, third capacitor C3, fourth capacitor C4, second diode D2, third diode D3, voltage-regulator tube W1 and third triode Q3;

The emitting electrode of third triode Q3 is grounded and the collector electrode is connected to controller 3.

The input of first instrument transformer L1 is connected to the load detection startup circuit, and its output is connected to the input of first rectifier bridge Z1;

The output of first rectifier bridge Z1 connects in parallel with tenth resistor-R10, eleventh resistor R11, twelfth resistor R12, third capacitor C3, fourth capacitor C4, second diode D2, respectively;

The positive electrode of the output of first rectifier bridge Z1 is connected to base electrode of third triode Q3 through third diode D3, voltage-regulator tube W1 and thirteenth resistor R13, with the negative electrode being grounded;

The emitting electrode of third triode Q3 is grounded and collector electrode is connected to controller 3.

It is understood that, after the load detection start circuit is started, the input of first transformer L1 is connected to the load detection startup circuit to introduce current, and its output is connected to the input of first rectifier bridge Z1.

After the first rectifier bridge Z1 is rectified that one part is connected to ground and the other part is shunted through tenth resistor R10 and third diode D3. When the input current of the first transformer L1 is too large during the operation of the overcurrent detection circuit, the voltage across the fourth capacitor C4 further rises rapidly, which is higher than the regulated value of the voltage regulator W1, and the current goes through the voltage regulator W1 and thirteenth resistor R13 to get to the third triode Q3's base electrode, resulting in third transistor Q3 conductive. The collector electrode of the third triode Q3 is connected to controller 3, and when the third triode Q3 is on, it outputs a low electric level to controller 3, resulting in the shutoff after the controller receives such low electric level, to prevent the load from burning due to excessive current or other problems.

Preferably, the collector electrode of the third triode Q3 is connected to controller 3 through a delay circuit, resulting in the controller 3 to re-control the input for power delivery after a set delay time.

Referring to FIG. 4, an automatic chicken coop door further includes: leakage detection circuit;

The leakage detection circuit comprises:

External power source, second instrument transformer L2, second rectifier bridge Z2, fourteenth resistor R14, fifteenth resistor R15, sixteenth resistor R16, fifth capacitor C5, fourth diode D4, fifth diode D5, sixth diode and a comparator U3;

The input of second instrument transformer L2 is connected to load detection startup circuit and its output is connected to the input of second rectifier bridge Z2;

The positive electrode of the output of second rectifier bridge Z2 is connected to the first negative electrode of the input of comparator U3 through fourteenth resistor R14; further connected to the first negative electrode of the input of comparator U3 through fourth diode D4; further connected to the first negative electrode of the input of comparator U3 through fifteenth resistor R15; and further grounded through fifth capacitor C5;

The external power source is connected to the first positive electrode of the input of comparator U3 through sixteenth resistor R16; is further connected to the second positive electrode of comparator U3;

The sixteenth resistor-R16 is further grounded through fifth diode-D5;

The second negative electrode of comparator U3 is grounded;

The output of the comparator U3 is connected to the controller-3 through sixth diode D6.

When there is no leakage in the load detection start circuit, the currents flowing in the second transformer L2 of the leakage detection circuit are in opposite phases and cancel each other out, resulting in no voltage output from second transformer L2. When there is a leakage in load detection start circuit, the second transformer L2 carries out voltage output, and the voltage is rectified in the second rectifier bridge Z2 and then flows through the fourteenth resistor R14 to the first negative input of comparator U3 from the positive output of the second rectifier bridge Z2. At this time, the 12V external power source is connected to the first positive input of comparator U3 through the sixteenth resistor R16, and to the second positive input of comparator U3, and the sixteenth resistor R16 is further grounded through the fifth diode D5. When the voltage of the first negative input of comparator U3 is higher than that of the first positive input, the output of comparator U3 outputs a low electrical level, which is sent to controller 3 through the sixth diode D6, resulting in the shutoff after the controller receives such low electric level, to prevent the load from burning due to excessive current or other problems.

Preferably, the collector electrode of the sixth diode D6 is connected to controller 3 through a delay circuit, resulting in the controller 3 to re-control the input for power delivery after a set delay time.

### Exemplary Embodiment III

A chicken coop comprises:

The main body of the chicken coop, and an automatic chicken coop door as in any of the above-mentioned exemplary embodiments.

The chicken coop in this exemplary embodiment, as configured with an automatic chicken coop door as in any of the above-mentioned exemplary embodiments, makes it possible to complete the automatic opening/closing of the door body when reaching preset trigger conditions through the synchronization of the trigger device and the motor, which is not only more convenient for the control of controlling the chicken coop door body, but also saves human resources.

It is understood that the same or similar parts in the above-mentioned exemplary embodiments can be cross-referenced, and what is not detailed in some exemplary embodiments can be found in other exemplary embodiments that are identical or similar.

It should be noted that in the description of the present application, the terms “first”, “second”, etc. are used for descriptive purposes only and should not to be construed as indicating or implying relative importance. In addition, for the description of this application, unless otherwise specified, “a plurality of” means at least two ones.

It should be understood that the various parts of the present application may operate by using any hardware, software, firmware, or a combination thereof. In the above-mentioned exemplary embodiments, a plurality of steps or methods may be implemented with software or firmware stored in memory and executed by an appropriate instruction execution system. If implemented by hardware, for example, as in another embodiment, any of the following techniques or combinations thereof are known in the art: the discrete logic circuit with logic gates to implement the logic function on data signals, the specialized integrated circuit with appropriate combinational logic gates, programmable gate array (PGA), field programmable gate array (FPGA), etc.

A person skilled in the art can understand that all or some of the steps carried out to implement the method of the above-mentioned exemplary embodiments can be accomplished by instructing the relevant hardware by means of a program, the program can be stored in a computer readable storage medium which, when executed, comprises one of the steps of a method-based exemplary embodiment or a combination thereof.

In addition, each functional unit in each exemplary embodiment of the present application may be integrated in a processing module, or the individual units may physically exist separately, or two or more units may be integrated in one single module. The above-mentioned integrated modules can be implemented either in the form of hardware or of software function module. The above-mentioned integrated modules may further be stored in a computer readable storage medium if being implemented in the form of software function module and then sold or used as a standalone product.

The above-mentioned storage media may be ROMs, disks or CDs, etc.

In this Description, reference to the terms “an exemplary embodiment,” “some exemplary embodiments”, “examples,” “specific examples,” or “some examples” and the like, means that the specific features, structures, materials, or characteristics described within the exemplary embodiment or examples are included in at least one exemplary embodiment or example of the present application. And in this specification, the schematic representation of the above-mentioned terms does not necessarily refer to the same exemplary embodiment or example. Moreover, the specific features, structures, materials, or characteristics described may be combined in any one or more exemplary embodiments or examples in an appropriate manner.

While the above-mentioned exemplary embodiments of the present application have been shown and described, it is understood that these embodiments are illustrative and should not be construed as limiting the present application and that variations, modifications, replacements and variants of the above-mentioned exemplary embodiments may be made by those skilled in the art within the scope of the present application.

1. An automatic chicken coop door, comprising:
a door body, a trigger device, a controller and a motor;
wherein the door body is set at the periphery of the chicken coop;
the trigger device is used to send a trigger signal to the controller when reaching preset trigger conditions;
the controller is used to control the motor to drive the door body to open/close according to the trigger signal.

2. An automatic chicken coop door of claim 1, wherein the trigger device comprises:
a timer;
wherein the timer is used to send a first timing trigger signal to the controller when reaching a first preset time; to send a second timing trigger signal to the controller when reaching a second preset time;
the controller, according to the first timing trigger signal, control the motor to drive the door body open; and according to the second timing trigger signal, control the motor to drive the door body closed.

3. An automatic chicken coop door of claim 1, wherein the trigger device comprises:
a photosensitive sensor;
wherein the photosensitive sensor is used to send a first light trigger signal to the controller when receiving a first preset brightness; send a second light trigger signal to the controller when receiving a second preset brightness;
the controller controls the motor to drive the door body to open according to the first light trigger signal; and controls the motor to drive the door body to close according to the second light trigger signal.

4. An automatic chicken coop door of claim 1, wherein the trigger device comprises:
a remote control device;
wherein the remote control device is used to send a remote control trigger signal to the controller;
the controller controls the motor to drive the door body to open/close according to the remote control trigger signal.

5. An automatic chicken coop door of claim 1, further including an indicator light and an infrared sensor;
wherein the controller controls the indicator light to send a first indication while controlling the motor to drive the door body to open; controls the indicator light to send a second indication while controlling the motor to drive the door body to close;
the infrared sensor is set on the side of the door body;
the controller, while controlling the motor to drive the door body to close, detects infrared information at the door body by the infrared sensor, and controls the motor to bounce open when infrared activity information other than that of the door body is detected at the door body.

6. An automatic chicken coop door of claim 1, further including a load detection startup circuit;
wherein the load detection startup circuit comprises:
a first output, a second output, a third output, a fourth output, a first input, a second input, a first triode, a second triode, a first resistor, a second resistor, a third resistor, a fourth resistor, a fifth resistor, a sixth resistor, a seventh resistor, a first switch, a second switch, a first diode and a first photo-coupler;
the first triode is NPN-type and said second triode is PNP-type;
the controller is connected to the first output, second output, third output, fourth output, first input, second input and first photo-coupler, respectively;
the first input and second input are connected to a power source;
the first triode has: emitting electrode connected to the first input; base electrode connected to the first input through the first resistor, and further connected to the first output and the second output through the second resistor and the third resistor; collector electrode connected to the first photo-coupler;
the second triode has: emitting electrode connected to the second input; base electrode connected to the second input through the seventh resistor, and further connected to the third output and the fourth output through the fourth resistor and the fifth resistor; collector electrode connected to the first photo-coupler through the sixth resistor and the first diode;
the first switch is connected to both ends of the first resistor and the third resistor;
the second switch is connected to both ends of the fourth resistor and the seventh resistor.

7. An automatic chicken coop door of claim 6, further including a moisture detection circuit;
where the moisture detection circuit comprises:
a first moisture detection loop circuit, a second moisture detection loop circuit, a first capacitor, a second capacitor, an eighth resistor, a ninth resistor and a second photo-coupler;
the controller is further connected to the second photo-coupler;
the first moisture detection loop circuit surrounds the first output and the second output, and is connected to the second photo-coupler through the eighth resistor;
the second moisture detection loop circuit surrounds the third output and the fourth output, and is connected to the second photo-coupler through the ninth resistor;
the first input is connected to the second photo-coupler through the first capacitor;
the second input is connected to the second photo-coupler through the second capacitor.

8. An automatic chicken coop door of claim 6, further including an overcurrent detection circuit;
where the overcurrent detection circuit comprises:
a first instrument transformer, a first rectifier bridge, a tenth resistor, an eleventh resistor, a twelfth resistor, a thirteenth resistor, a third capacitor, a fourth capacitor, a second diode, a third diode, a voltage-regulator tube and a third triode;
the input of the first instrument transformer is connected to the load detection startup circuit, and its output is connected to the input of the first rectifier bridge;
the output of the first rectifier bridge connects in parallel with the tenth resistor, eleventh resistor, twelfth resistor, third capacitor, fourth capacitor, and second diode, respectively;
the positive electrode of the output of the first rectifier bridge is connected to base electrode of the third triode through the third diode, voltage-regulator tube and thirteenth resistor, with the negative electrode being grounded;
the emitting electrode of the third triode is grounded and collector electrode is connected to the controller.

9. An automatic chicken coop door of claim 6, further including a leakage detection circuit;
wherein the leakage detection circuit comprises:
an external power source, a second instrument transformer, a second rectifier bridge, a fourteenth resistor, a fifteenth resistor, a sixteenth resistor, a fifth capacitor, a fourth diode, a fifth diode, a sixth diode and a comparator;
the input of the second instrument transformer is connected to the load detection startup circuit, and its output is connected to the input of the second rectifier bridge;
the positive electrode of the output of the second rectifier bridge is connected to the first negative electrode of the input of the comparator through the fourteenth resistor; further connected to the first negative electrode of the input of the comparator through the fourth diode; further connected to the first negative electrode of the input of the comparator through the fifteenth resistor; and further grounded through the fifth capacitor;
the external power source is connected to the first positive electrode of the input of the comparator through the sixteenth resistor; is further connected to the second positive electrode of the comparator;
the sixteenth resistor is further grounded through the fifth diode;
the second negative electrode of the comparator is grounded;
the output of the comparator is connected to the controller through the sixth diode.

10. A chicken coop, comprising:
a chicken coop body, and an automatic chicken coop door as claimed in claim 1.
